(19) United States
(12) Patent Application Publication
(10) Pub. No.: US 2010/0071853 A1
(43) Pub. Date: Mar. 25, 2010

(54) Tape Dispenser

(76) Inventor: Chien-Lung Wu, Ta Jwu Li (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/429,367

(22) Filed: Apr. 24, 2009

(30) Foreign Application Priority Data
Sep. 23, 2008 (TW) 97136545

(51) Int. Cl. B32B 37/00

(52) U.S. Cl. 156/538

(57) ABSTRACT

A tape dispenser includes a case, a connector mounted in the case, and an application tip which is adapted to be reactively tilted by the surface so that the tip accomplishes good adhering to the surface. The application tip includes an end received in the connector and is rotatable about a longitudinal axis thereof in both clockwise and counterclockwise directions. Further, the tape dispenser includes a restraining mechanism for limiting an angle of rotation of the application tip.

### BACKGROUND OF THE INVENTION

1. Field of the Invention

The present invention relates to a tape dispenser and, in particular, to a tape dispenser which includes an application tip that is pressed on a surface during operation thereof and which is adapted to be reactively tilted by the surface so that the tip accomplishes good adhering to the surface.

2. Description of the Related Art

Correction tape is an alternative to correction fluid used to correct errors during writing and it is appreciated that correction tape utilizes a tape which is in solid form for masking errors and, whereas correction fluid is in liquid form and only after the fluid is dried would it be possible to create a correction. Additionally, it is appreciated that the correction tape is not subject to a misuse as an inhalant. Because of its usefulness, there is known that a product utilizes this type of dispenser to dispense a decorative tape.

A correction tape generally includes an application tip which is moved against a surface during operation thereof. Generally, the surface is referred to as a plane on which the tape of the correction tape is applied. A problem that the application tip commonly suffers is that it doesn't adhere to the surface.

U.S. Pat. No. 7,228,882 discloses a correction tape including an application tip which includes a pivot shaft that is pivotally installed in a case. Thus, the application tip is pivotally moveable about the pivot shaft i.e. upward and downward for accomplishing an alignment on a surface. Further, a cushion body provides cushioned pivoting of the application tip. However, it is noted that the pivot shaft often breaks when the correction tape accidentally drops from a height. Additionally, it is discovered that for the application tip to gain a good adhering to the surface, the application tip better be rotatable about a longitudinal axis thereof.

The present invention is, therefore, intended to obviate or at least alleviate the problems encountered in the prior art.

### SUMMARY OF THE INVENTION

According to the present invention, a tape dispenser includes a case, a connector mounted in the case, and an application tip which is adapted to be reactively tilted by the surface so that the tip accomplishes good adhering to the surface. The application tip includes an end received in the connector and is rotatable about a longitudinal axis thereof in both clockwise and counterclockwise directions. Further, the tape dispenser includes a restraining mechanism for limiting an angle of rotation of the application tip.

In one preferred embodiment, the restraining mechanism includes a clip having two engaging sections opposite to each other. Further, the clip is rotatably engaged with the two lateral sides of the connector. Additionally, the connector includes a stopping member formed thereon and between which the two engaging sections of the clip selectively abut for limiting the angle of rotation of the application tip.

In another preferred embodiment, the means includes a channel disposed on the connector. The channel has a closed cross section and an aperture therein extending longitudinally for receiving the application tip. Further, the application tip includes a fin disposed in the aperture, and the channel includes two opposite sides against which the fin selectively abuts for limiting the angle of rotation of the application tip.

It is an object of the present invention to provide a tape dispenser that includes a connector which is fixedly mounted in first and second half cases and an application tip which is securely mounted in the connector. Thus, the application tip is prevented from undesired loosening and movement.

It is yet another object of the present invention to provide a tape dispenser that includes a rotatable application tip for gaining a good adhering to a surface on which a tape is applied.

It is a further object of the present to provide a tape dispenser that includes a returning mechanism for moving an application tip to an unrotated position.

It is a further object of the present invention to provide a tape dispenser that includes a covering mechanism which is moveable to selectively shield an application tip.

It is a further object of the present invention to provide a tape dispenser that includes an application tip which is pivotally connected to a connector such that the application tip more bearable to a force during operation thereof.

It is a further object of the present invention to provide a tape dispenser that includes an application tip which is rotatably restrained such that the application tip is prevented from over-rotating undesirably to adversely effect on the quality of taping.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

The present invention will be described with reference to the accompanying drawings which assist in illustrating the pertinent features thereof, in which:

FIG. 1 is a perspective view of a tape dispenser in accordance with a first embodiment of the present invention.

FIG. 2 is an exploded perspective view of the tape dispenser shown in FIG. 1.

FIG. 3 is a partial, enlarged perspective view of the application tip shown in FIG. 1.

FIG. 4 is an exploded perspective view of FIG. 3.

FIG. 5 is a side view of the tape dispenser in which a covering mechanism is in a position revealing the application tip.

FIG. 6 is an extended view of FIG. 5 in which the covering mechanism in a position shielding the application tip.

FIG. 7 is a bottom view of FIG. 3, illustrating the application tip is adapted to be rotated about a longitudinal axis thereof.

FIG. 8 is a cross-sectional view taken along line 8-8 of FIG. 3, with the application tip in a position shown in FIG. 7.

FIG. 9 is a cross-sectional view taken along line 9-9 of FIG. 3, with the application tip in a position shown in FIG. 7.

FIG. 10 is an extended view of FIG. 7, illustrating the application tip is returned to an unrotated position.

FIG. 11 is cross-sectional view taken along line 8-8 of FIG. 3, with the application tip in the unrotated position shown in FIG. 10.

FIG. 12 is a cross-sectional view taken along line 9-9 of FIG. 3, with the application tip in the original position shown in FIG. 10.

FIG. 13 is a side view of FIG. 3, illustrating the application tip is adapted to be pivoted up and down.

FIG. 14 is a perspective view of a tape dispenser in accordance with a second embodiment of the present invention.

FIG. 15 is an exploded perspective view of FIG. 14.

FIG. 16 is a cross-sectional view of the tape dispenser shown in FIG. 14.

FIG. 17 is a cross-sectional view taken along line 17-17 of FIG. 16.

FIG. 18 is a perspective view illustrating the application tip is adapted to be rotated about a longitudinal axis thereof.

FIG. 19 is an extended view of the FIG. 17, illustrating the application tip in another position.

FIG. 20 is an extended view of the FIG. 17, illustrating the application tip in yet another position.

### DETAILED DESCRIPTION OF THE PREFERRED EMBODIMENT

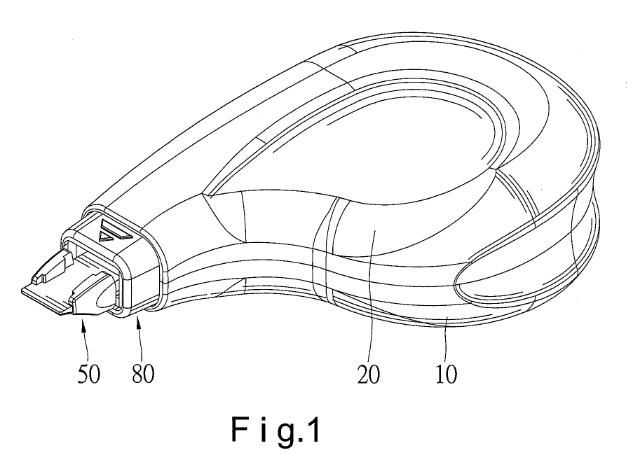

FIGS. 1 though 5 show a tape dispenser in accordance with a first embodiment of the present invention. A tape dispenser includes a case which may include a first half case 10 and a second half case 20 joined with the first case 10. When the first and second half cases 10 and 20 are joined together, the cases define an enclosed room with an opening. In the preferred embodiment, the room is a combination of a first compartment 13 which is defined in a first section 11 of the first half case 10 and a second compartment 23 which is defined in a first section 21 of the second half case 20. Further, the joined first and second half cases 10 and 20 include an opening which is delimited by a first peripheral wall 15 which is defined in a second section 12 of the first half case 10 and a second peripheral wall 25 which is defined in a second section 22 of the second half case 20.

A spool mechanism 30 for receiving a tape which has an application layer and a carrier tape is rotationally mounted in the case. In the preferred embodiment, the case includes a column 14 about which the spool mechanism 30 rotates. The column 14 is formed in the first half case 10. Further, an axle 24 may be formed in the second half case 20 for joining with the column 14 such that the column 14 is engaged with the axle 24 when the first half case 10 and second half case 20 are joined.

A connector 40 is also mounted in the case and is prevented from movement by first and second retaining members 19 and 29, which are formed on the first half and second half cases 10 and 20 respectively. In this embodiment, the connector 40 includes a first end 41 including a bottom wall 411, two lateral walls 412 extending therefrom upwardly and two recesses 413 formed on the two lateral walls 412 respectively for connecting a returning mechanism 70, which will be further discussed hereafter. The connector 40 further includes a second end 42 including two lateral sides defining a space 43 therebetween and between which an application tip 50 is disposed, which will be further discussed hereafter.

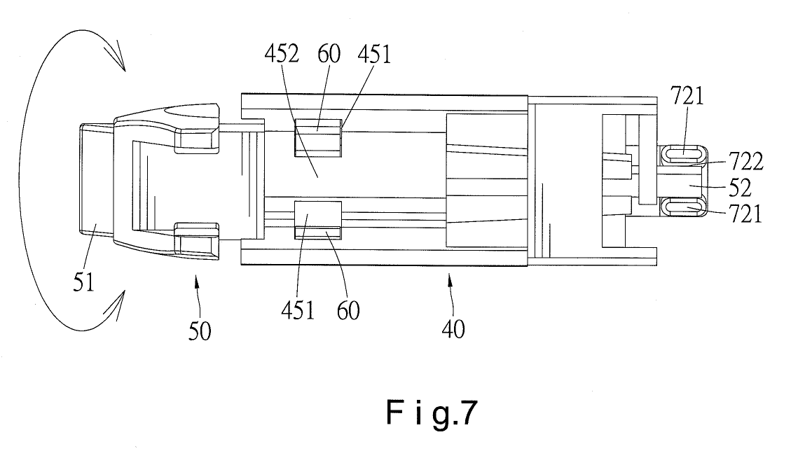

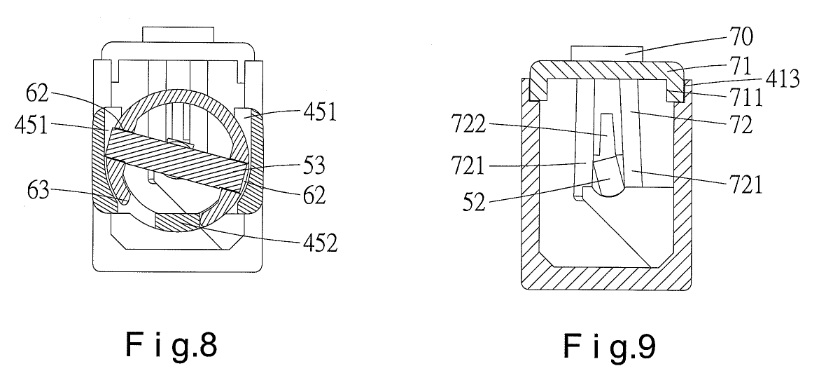

The application tip 50 includes an end that is disposed in the case and is rotatably received in the connector 40 such that the application tip 50 is rotatable about a longitudinal axis thereof in both clockwise and counterclockwise directions (as shown in FIG. 7). A restraining mechanism 60 is utilized for limiting an angle of rotation of the application tip 50. In this embodiment, the restraining mechanism 60 includes a clip with two engaging sections 63 opposite to each other and may include an opening 61 defined between two engaging sections 63. The clip is rotatably engaged with the two lateral sides of the connector 40. Preferably, the connector 40 includes a groove 451 extending transversely to a longitudinal axis of the second end 42 of the connector 40 and between the two lateral sides for engaging the clip. The connector 40 includes a stopping member 452 formed thereon, and between which the two engaging sections 63 of the clip selectively abuts (as shown in FIG. 8) for limiting the angle of rotation of the application tip 50.

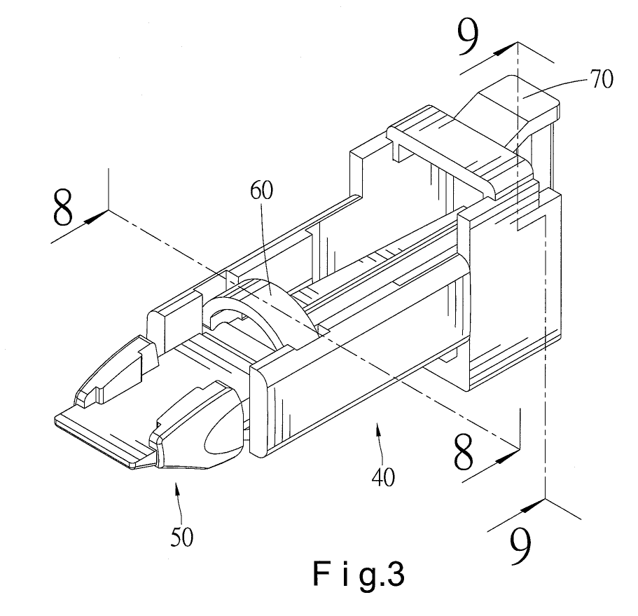

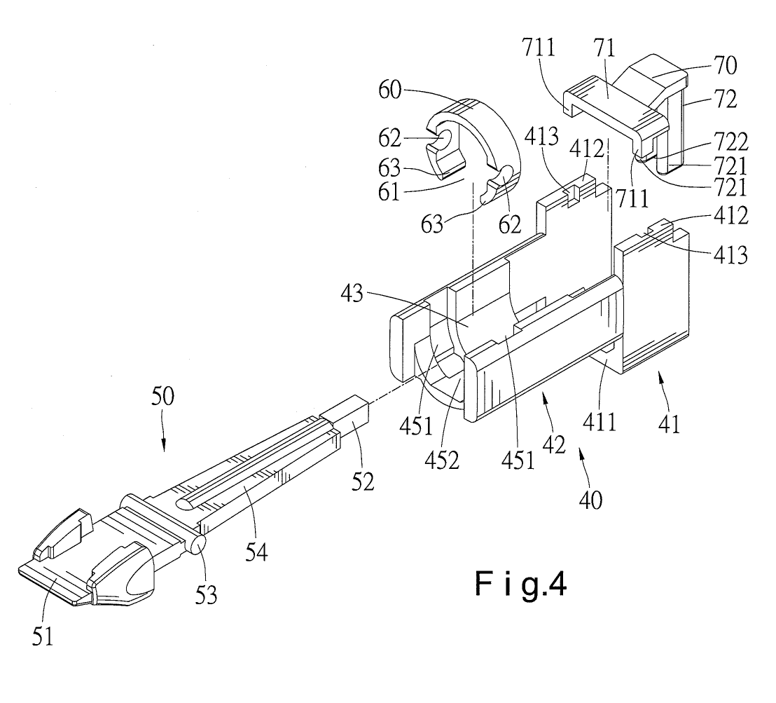

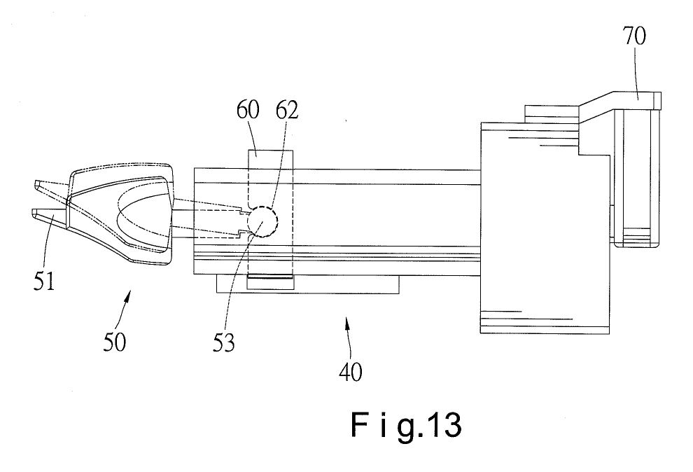

FIG. 4 also shows the clip includes two receiving sections 62 opposite to each other and the application tip 50 includes a connection section 53 extending transversely to the longitudinal axis of the application tip 50. The connection section 53 includes two ends that are received in the two receiving sections 62 respectively (as shown in FIG. 3). Additionally, the application tip 50 includes another end 51 which is pivotal about the connection section 53 in both upward and downward directions (as shown in FIG. 13).

Still referring to FIG. 4, the returning mechanism 70 which is preferably connected to the connector 40 includes a connecting end 71 for joining with the connector 40. The connecting end 71 includes two protrusions 711 for engaging with the two recesses 413 respectively. The returning mechanism 70 further includes an engaging end 72 for guiding the application tip 50 to an unrotated position, which will be described thereafter. It is understood that the tape guide 70 would also guide the tape that is reeled out from the spool mechanism 30 and that is received by the application tip 50 is a known art. Therefore, no further explanation thereof will be given herein.

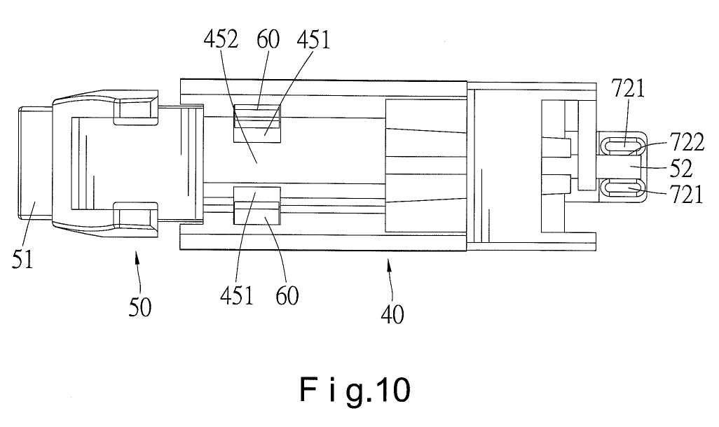

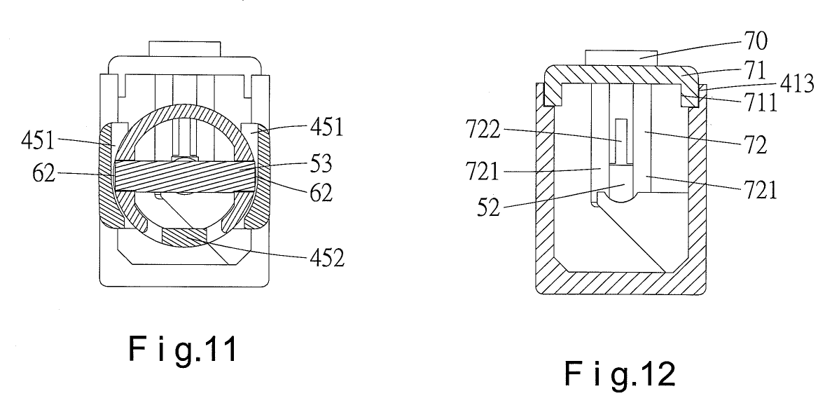

The engaging end 72 is utilized to engage with the application tip 50 for returning the application tip 50 from a rotated position to the unrotated i.e. original position. Preferably, the original position is referred to as a position in which the end 51 is horizontal. The engaging end 72 includes two parallel arms 721 with resilient characteristic and disposed in a spaced relation and the two arms 721 define a gap 722 therebetween and between which a connecting portion 52 of the application tip 50 is engaged. Preferably, the connecting portion 52 has a polygonal geometry. Preferably, the application tip 50 has a body 54 and the connecting portion 52 is connected to an end of the body 54. The connecting portion 52 is rotatable with the application tip 50 and is adapted to urge free ends of the two arms 721 in opposite directions (as shown in FIG. 9) when the application tip 50 is in rotated through an angle of rotation (as shown in FIG. 8). It is understood that the two arms 721 are extended from the returning mechanism 70 and each has a first end connected to the returning mechanism 70 and a second end unrestrained. Thus, the first end connected to the returning mechanism 70 is referred as a fixed end, whereas the unrestrained second end is referred as a free end. Further, the free ends of the two arms 721 are adapted to be returned in order to the application tip 50 is in the original position (as shown in FIGS. 10 and 11).

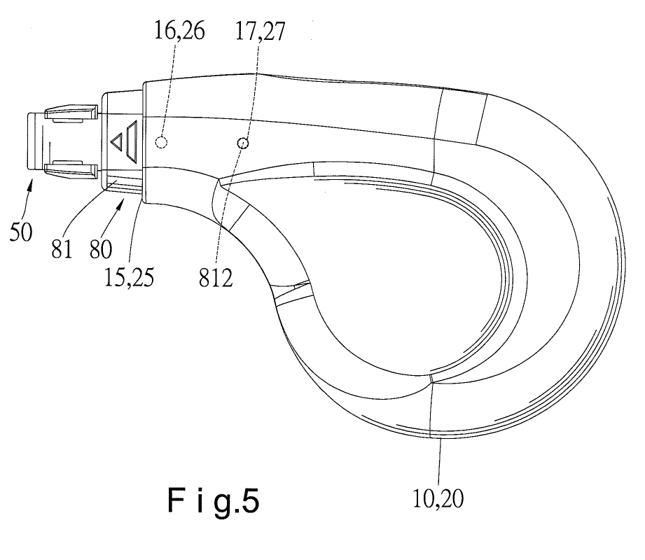

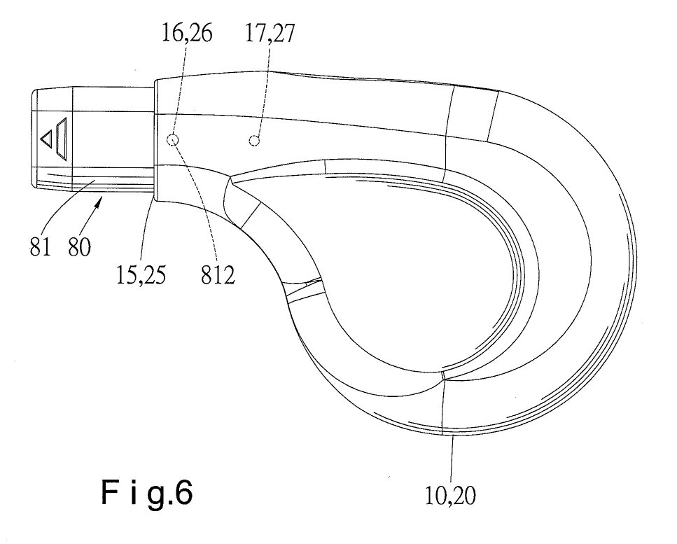

The tape dispenser further includes a covering mechanism 80 that is moveably connected to the first and second half cases 10, 20. FIGS. 5 and 6 show that the covering mechanism 80 is moveable between a first position where the application tip 50 is exposed and a second position where the application tip 50 is shielded. Additionally, the covering mechanism 80 includes two engaging members 812 that engage with first and third positioning sections 16 and 26 respectively when the covering mechanism 80 is retained in the second position and that engage with second and fourth positioning sections 17 and 27 when the covering mechanism 80 is retained in the first position. In the preferred embodiment, the first and second positioning sections 16 and 17 may be configured as apertures defined in the first half case 10, whereas the third and fourth positioning sections 26 and 27 may be configured as apertures defined in the second half case 20. Moreover, to release the covering mechanism 80 from the locked first position, the engaging members 812 are depressed to disengage from the second and fourth positioning sections 17 and 27. Likewise, to release the covering mechanism 80 from the locked second position, the engaging members 812 are depressed to disengage from the first and third positioning sections 16 and 26. Further, at least one cutout 813 may be utilized to facilitate the depression of the engaging members 812.

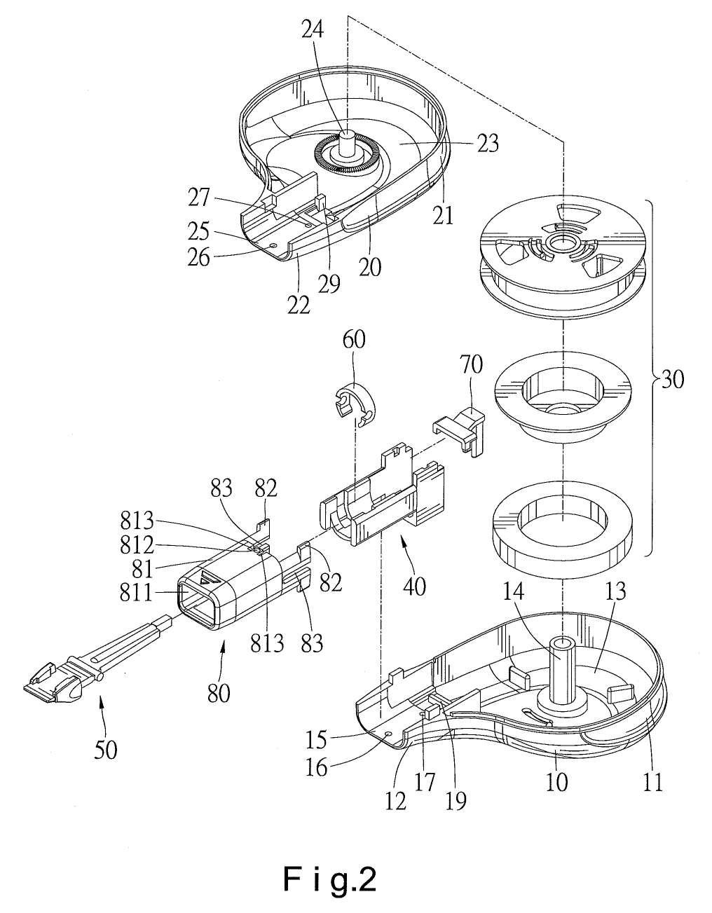

FIG. 2 also shows the covering mechanism 80 includes an annular shell 81 which defines a passage 811 therein extending longitudinally. The connector 40 is adapted to be partially received in the passage 811. Further, the covering mechanism 80 includes two parallel connecting legs 82 extending from the annular shell 81 longitudinally and disposed in a spaced relation. Additionally, when the covering mechanism 80 is in the second position, the two connecting legs 82 abut against the first and second half cases 10 and 20 for preventing the covering mechanism 80 from detachment from the first and second half cases 10 and 20. Further, a slit 83 extends longitudinally on each connecting leg 82 for enabling the associated connecting leg 82 to be biased with resiliency transversely to a longitudinal axis thereof.

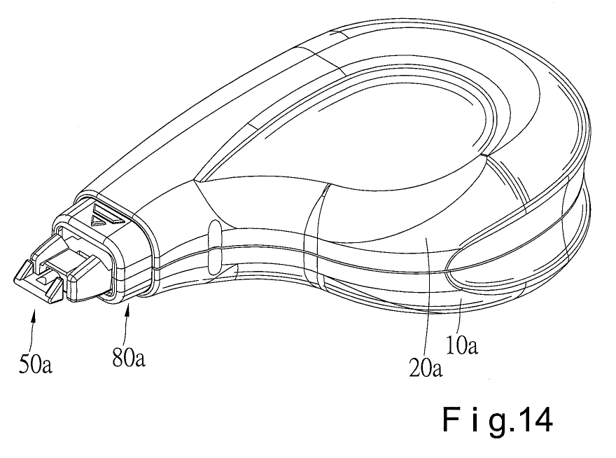

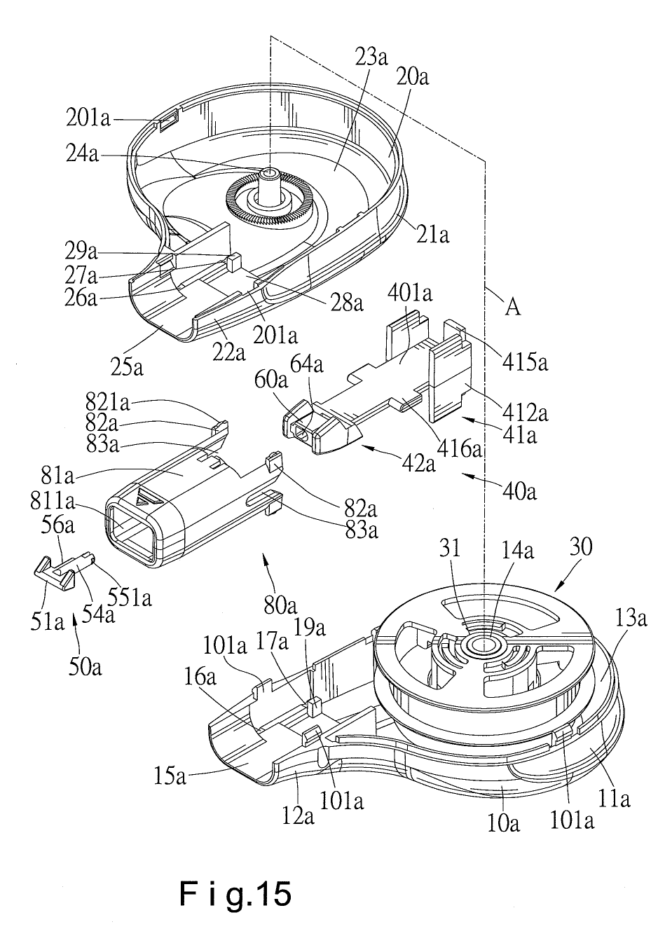

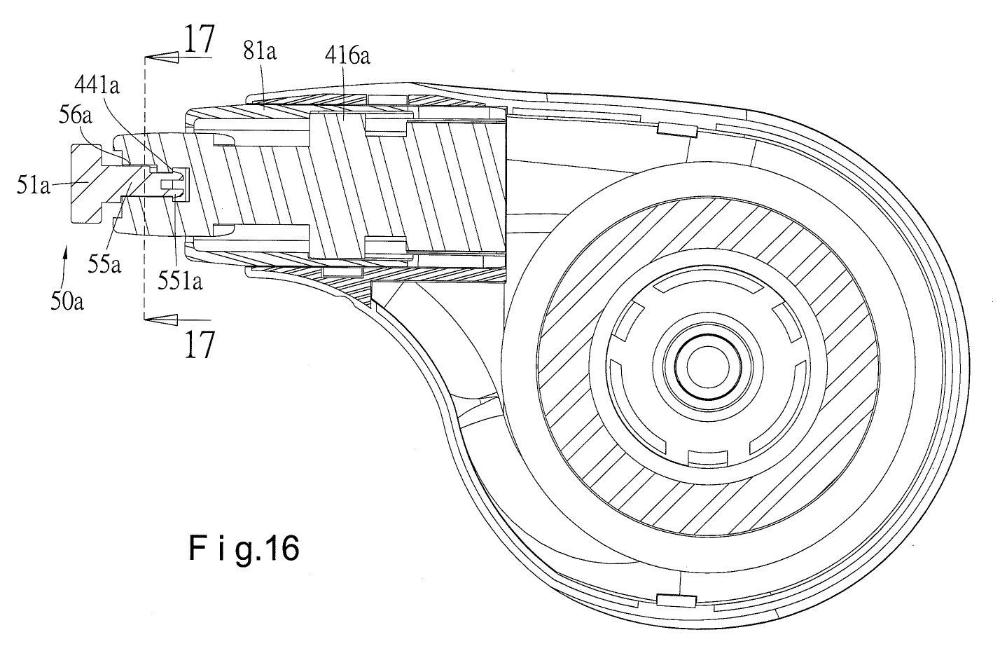

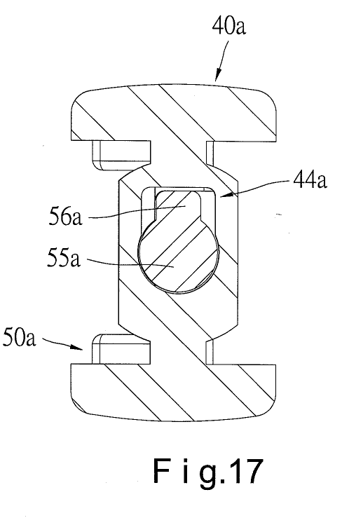

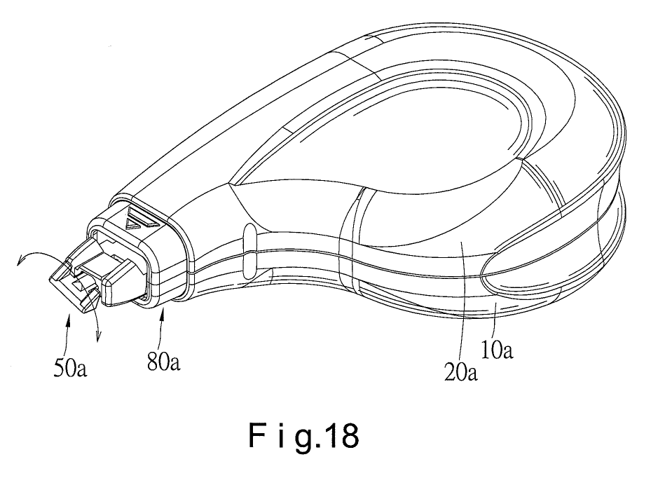

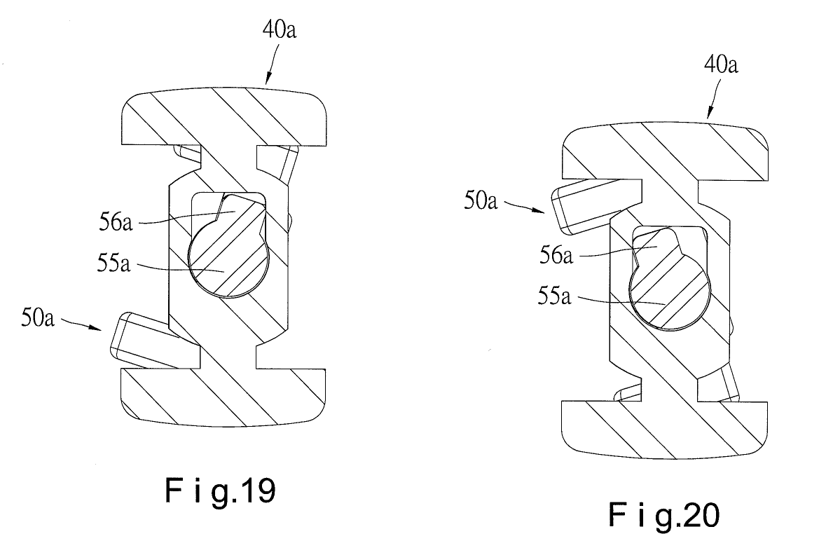

FIGS. 14 and 15 show a tape dispenser in accordance with a second embodiment of the present invention and wherein the like numerals are employed to the like components except including a suffix a. In this embodiment, a first half case 10a further includes a pair of catches 101a and a second half case 20a further includes a pair of notches 201a that engage with the pair of catches 101a respectively when the first half and second half cases 10a and 20a are joined. Thus, the first half and second half cases 10a and 20a are firmly attached to each other and the first half and second half cases 10a and 20a would not disintegrate from each other if the tape dispenser is accidentally dropped and impacted by the ground. Further, a connector 40a includes a flexible plane 401a such that the application tip 50a is adapted to be pivoted in both upward and downward directions. Moreover, the connector 40a includes two lateral walls 412a and a tape guide wall 415a so that a returning mechanism is eliminated. Further, a restraining mechanism 60a includes a channel with a closed cross-section and includes an aperture 64a therein extending longitudinally. The channel is disposed on the connector 40a. Additionally, the aperture 64a includes a shoulder 441a that connects between two sections thereof, and with one section having a diametrical length greater than the other. An application tip 50a is received in the aperture 64a and includes a hook 551a engaged with the shoulder 441a for preventing the application tip 50a from being pulled out of the aperture 64a.

The application tip 50a further includes a fin 56a disposed in the aperture 64a, and the fin 56a is rotatable with the application tip 50a, and the channel includes two opposite sides against which the fin 56a selectively abuts for limiting the angle of rotation of the application tip 50a. Preferably, the angle of rotation is 15 degrees in either clockwise or counterclockwise directions.

The connector 40a further includes two wings 416a extending oppositely and transversely to the longitudinal axis thereof, and the two wings 416a are received in two slits 83a respectively for maintaining an orientation of the covering mechanism 80a.

Two engaging members 821a which are engagable with positioning sections 16a, 17a, 26a and 27a are formed on two connecting legs 82a. In this embodiment, the positioning sections 16a, 17a, 26a and 27a are configured as cavities.

Based on the forgoing, the application tip 50, 50a are therefore adapted to accomplishes good adhering to a surface on which the tape is applied.

While the specific embodiments have been illustrated and described, numerous modifications come to mind without significantly departing from the spirit of invention and the scope of invention is only limited by the scope of accompanying claims.

What is claimed is:

1. A tape dispenser comprising:
a case;
a spool mechanism rotationally mounted in the case and adapted to receive a tape having an application layer and a carrier tape;
a connector including a first end mounted in the case and a second end, with the second end including a restraining mechanism;
an application tip including an end rotatably received in the connector, with the application tip being rotatable about a longitudinal axis thereof; and
a restraining mechanism limits an angle of rotation of the application tip.

2. The tape dispenser as claimed in claim 1 wherein the restraining mechanism includes a clip having two engaging sections opposite to each other.

3. The tape dispenser as claimed in claim 2 wherein the restraining mechanism includes an opening defined between the two engaging sections.

4. The tape dispenser as claimed in claim 2 wherein the restraining mechanism includes two receiving sections opposite to each other, and wherein the application tip includes a connection section extending transversely to the longitudinal axis of the application tip, and wherein the connection section includes two ends received in the two receiving sections respectively.

5. The tape dispenser as claimed in claim 2 wherein the connector includes two lateral sides defining a space therebetween and between which the application tip is disposed, and wherein the restraining mechanism is rotatably engaged with the two lateral sides, and wherein the connector further includes a stopping member formed thereon and between which the two engaging sections of the clip selectively abut for limiting the angle of rotation of the application tip.

6. The tape dispenser as claimed in claim 1 further includes a returning mechanism including an engaging end having two parallel arms in a spaced relation, and with each arm having one fixed end and one free end.

7. The tape dispenser as claimed in claim 6 wherein the application tip includes a connecting portion engaged in between the two arms, and wherein the connecting portion is rotatable with the application tip and selectively urges the free ends of the two arms in opposite directions.

8. The tape dispenser as claimed in claim 1 further includes a covering mechanism moveably connected to the case, and wherein the covering mechanism is moveable between a first position where the application tip is exposed and a second position where the application tip is shielded.

9. The tape dispenser as claimed in claim 6 wherein the connecting portion has a polygonal geometry.

10. The tape dispenser as claimed in claim 7 wherein the covering mechanism includes an annular shell defining a passage therein extending longitudinally, and wherein the connector is adapted to be partially received in the passage, and wherein the covering mechanism further includes two parallel connecting legs extending from the annular shell longitudinally and in a spaced relation for abutting against the case.

11. The tape dispenser as claimed in claim 10 wherein each connecting leg including a slit extending longitudinally for enabling the associated connecting leg to be biased with resiliency transversely to a longitudinal axis thereof.

12. The tape dispenser as claimed in claim 1 wherein the restraining mechanism includes a channel having an aperture therein extending longitudinally, and with the channel having a closed cross-section, and wherein the channel is disposed on the connector.

13. The tape dispenser as claimed in claim 12 wherein the aperture includes a shoulder connecting between two sections thereof, with one section having a diametrical length greater than the other, and wherein the application tip is received in the aperture and includes a hook engaged with the shoulder for preventing the application tip from being pulled out of the aperture.

14. The tape dispenser as claimed in claim 12 wherein the application tip includes a fin disposed in the aperture, and wherein the fin is rotatable with the application tip, and wherein the channel includes two opposite sides against which the fin selectively abuts for limiting the angle of rotation of the application tip.

15. The tape dispenser as claimed in claim 12 further includes a covering mechanism moveably connected to the case, and wherein the covering mechanism is moveable between a first position the application tip is exposed and a second position the application tip is shielded.

16. The tape dispenser as claimed in claim 15 wherein the covering mechanism includes an annular shell defining a passage therein extending longitudinally, and wherein the connector is adapted to be partially received in the passage, and wherein the covering mechanism further includes two parallel connecting legs extending from the annular shell longitudinally and in a spaced relation for abutting against the case.

17. The tape dispenser as claimed in claim 16 wherein each connecting leg including a slit extending longitudinally for enabling the associated connecting leg to be biased with resiliency transversely to a longitudinal axis thereof.

18. The tape dispenser as claimed in claim 17 wherein the connector further includes two wings extending oppositely and transversely to the longitudinal axis thereof, and with the two wings received in the two slits respectively for maintaining an orientation of the covering mechanism.

19. The tape dispenser as claimed in claim 1 wherein the connector includes a plane with a flexible characteristic such that the application tip is adapted to be pivotal in both upward and downward directions.

20. The tape dispenser as claimed in claim 1 wherein the application tip is rotatable in both clockwise and counterclockwise directions.
